(19) United States
(12) Patent Application Publication
(10) Pub. No.: US 2012/0308291 A1
(43) Pub. Date: Dec. 6, 2012

(54) Novelty writing instrument with pneumatic feature

(76) Inventor: Zachary Tov Weiner, New York, NY (US)

(21) Appl. No.: 13/134,106

(22) Filed: May 31, 2011

(51) Int. Cl. B43K 29/00

(52) U.S. Cl. 401/195

(57) ABSTRACT

A novelty writing instrument with pneumatic feature with a rigid elongate hollow writing instrument housing, a pneumatic pump mechanism, a pneumatic pump activating push button, one or more flexible inflatable members and a relief valve. The pump mechanism is located within the hollow writing instrument housing. The pump activating button protrudes through an aperture on the surface of the housing and is activated when the user presses on the surface of the pneumatic push button. The inflatable members are attached in an air tight manner to the pneumatic pump. The housing has apertures that allow the flexible inflatable members to exit the housing when the pump mechanism is activated. The relief valve lets the user deflate the inflatable members. A preferred embodiment includes inflatable members are made of latex balloons.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of writing instruments and more specifically to a novelty writing instrument with pneumatic feature.

Novelty writing instruments such such as novelty pens and pencils have been marketed and sold for many years. A novelty writing instrument is one that has an additional feature added to the instrument that adds play value or a unique appearance. For example, U.S. Pat. No. 5,251,112 discloses a pen that includes flashing LEDs and music. U.S. Pat. No. 6,045,914 shows a pen that has a large heart shape on top that can be written on. Patent application 2008/017650 discloses a pen that has helical grooves on the outside of the barrel which allows a toy monkey to swivel up and down the outside of the barrel.

However, one technology that has not been applied to novelty writing instruments is pneumatics. No novelty pen to date has taken advantage of a miniature pneumatic pump mechanism to cause inflatable members to extend from the writing instrument when the user activates the pump mechanism.

### BRIEF SUMMARY OF THE INVENTION

The primary object of the invention is to provide a novelty writing instrument that includes a small pneumatic pump that can inflate one or more inflatable members when activated by the user.

Another object of the invention is to provide a novelty writing instrument that allows the user to deflate the inflatable members by pushing a button on the housing of the writing instrument.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a novelty writing instrument with pneumatic feature comprising: a rigid elongate hollow writing instrument housing, a pneumatic pump mechanism, a pneumatic pump activating push button, one or more flexible inflatable members, a relief valve, said pump mechanism located within said hollow writing instrument housing, said pump activating button protruding through an aperture on the surface of said hollow writing instrument housing, said pneumatic pump activated when the user presses on the surface of said pneumatic pump activating push button, said inflatable members attached in an air tight manner to said pneumatic pump, said housing having apertures that allow said flexible inflatable members to exit said housing when said pump mechanism is activated and said inflatable members are inflated, said inflatable members terminating in said relief valve, and said relief valve having a relief button that exits through an aperture in said writing instrument housing and is accessible to a user for deflating said inflatable members.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a front view of the invention with inflatable members not deployed.

FIG. 2 is a front view of the invention with inflatable members deployed.

FIG. 3 is a top view of the invention.

FIG. 4 is a rear view of the invention.

FIG. 5 is a front section view of the invention with the inflatable members not deployed.

FIG. 6 is a front section view of the invention with the inflatable members deployed.

FIG. 7 is a side section view of the invention.

FIG. 8 is a perspective view of the invention with a heart shaped inflatable member.

FIG. 9 is a perspective view of the invention with a light bulb shaped inflatable member.

FIG. 10 is a side view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

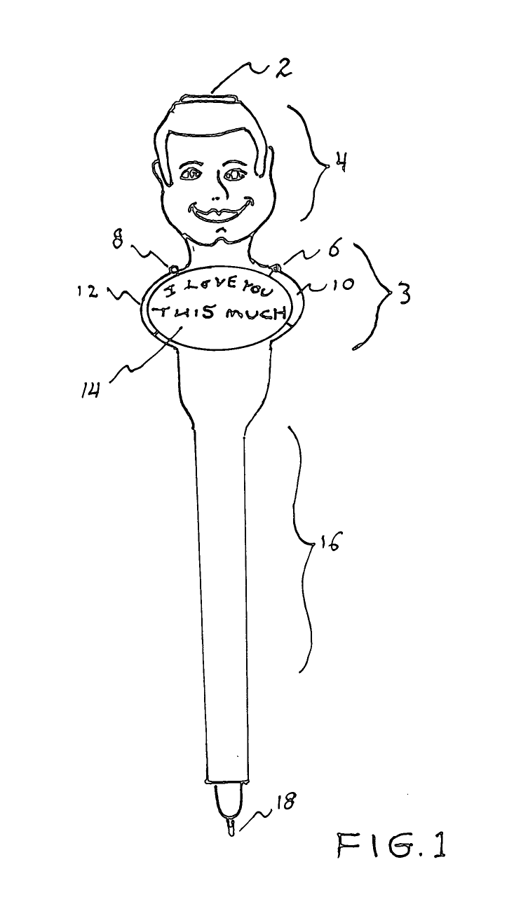

Referring now to FIG. 1 we see a front view of the novel pneumatic writing instrument of the present invention. In this case, the illustration shown is of a pen type writing instrument, however the scope of the invention is meant to cover other writing instruments such as a pencil or colored marker product. In the present embodiment, the main elongate hollow housing 16 terminates at one end in a pen writing portion 18 and at the other end, in a novel torso portion 3 and head portion 4 capped by a top push button 2.

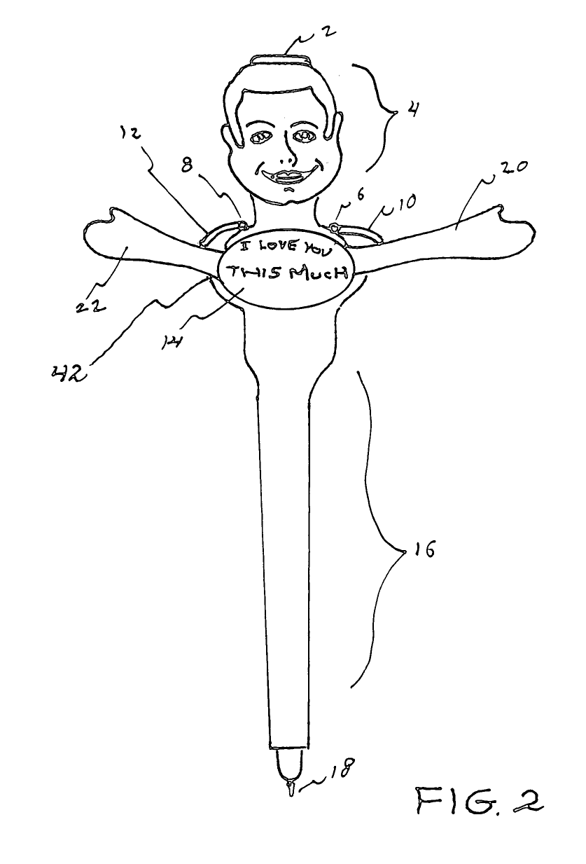

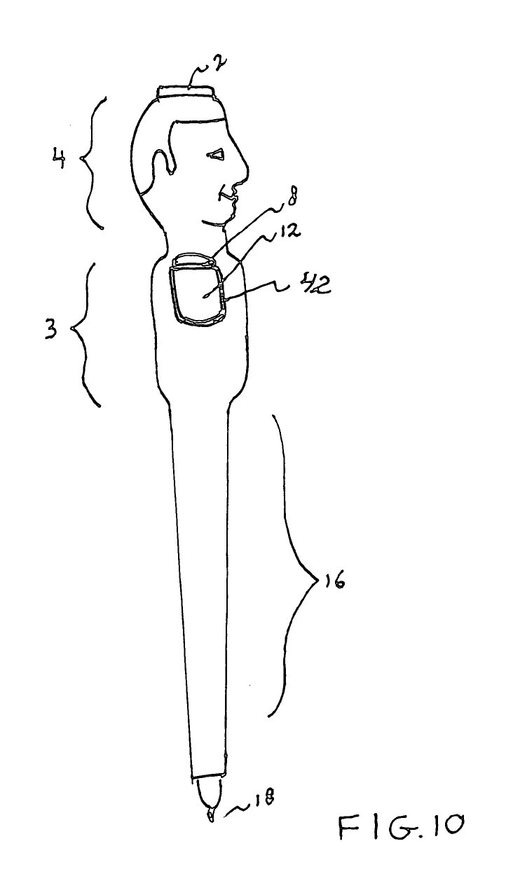

FIG. 2 is a front view of the invention with inflatable arms 20, 22 deployed. Panels 10, 12 rotate up via hinges 6, 8 to allow the inflated members 20, 22 to exit apertures 42 on the side of the torso housing as shown clearly in the side view in FIG. 10. Front graphic panel 14 includes a printed message such as “I love you this much”. Other messages can be printed on panel 14 which can be used for promotional purposes. For example “I love Pepsi this much”. Head portion 4 can be sculpted to have the likeness of a man, woman, child, animal or cartoon character head.

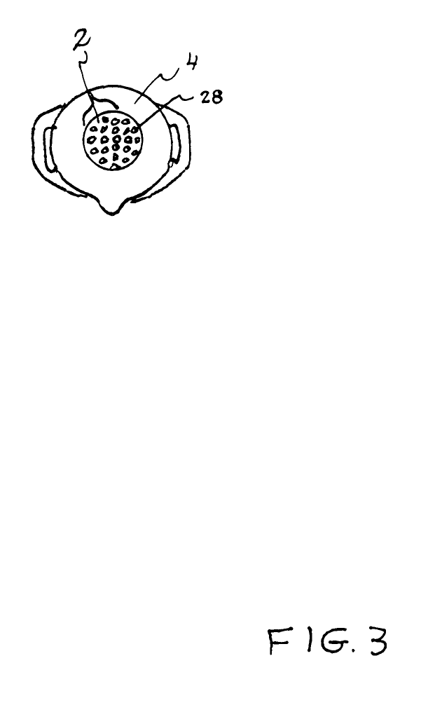

FIG. 3 shows a top view of the invention. Push cap 2 can be clearly seen on top of head portion 4. A plurality of apertures 28 allow air to enter and exit the cap 2 as needed.

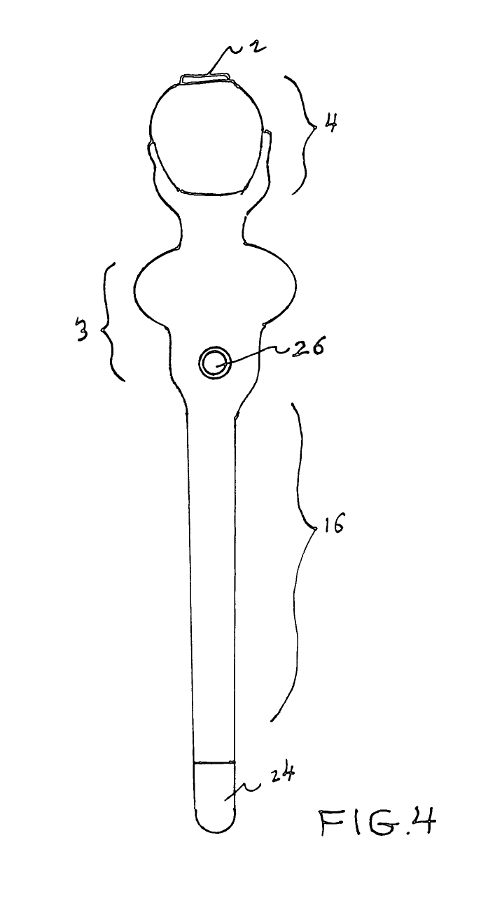

FIG. 4 is a rear view of the invention. Pressure relief valve push button 26 can be seen in the torso portion 3 of the invention. Additionally, a removable and replaceable standard pen cap 24 can be seen installed in a standard way at the lower end of the elongate member 16.

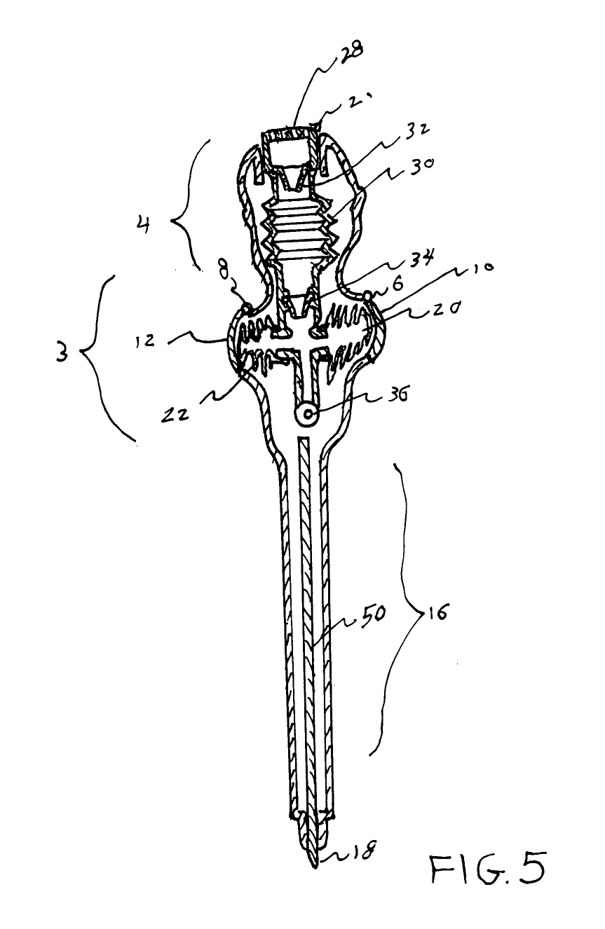

FIG. 5 shows a front section view that longitudinally bisects the elongate hollow housing 16, torso 3 and head portion 4. Standard pen cartridge 50 can be seen retained within the elongate hollow housing 16. Inflatable extension arms 20, 22 are in their collapsed form and retained within the torso portion 3 and held from exiting the torso by hinged panels 10, 12. When a user presses down on pneumatic cover button 2, flexible bellows portion 30 compresses causing trapped air within the bellows 30 to be forced out of duck bill check valve 34 and into the inflatable members 20, 22. The inflatable members 20, 22 can be latex balloons or can be other flexible inflatable members such as low density polyethylene bellows members. When the user releases push button 2, air is allowed to be drawn into apertures 28 and into duck bill check valve 32 which refills bellows 30. Bellows 30 is molded from low density polyethylene or similar material and has a spring like quality so that the bellows 30 automatically returns to its extended position after being pressed down by the user. In this way, multiple pressings of push button 2 causes the inflatable arm members 20, 22 be inflated and to extend further and further with each press of push button 2. A relief valve 36 is located at the termination point of inflatable members 20, 22. The relief valve can be activated by the user by pushing on relief push button 26 shown in the rear view in FIG. 4.

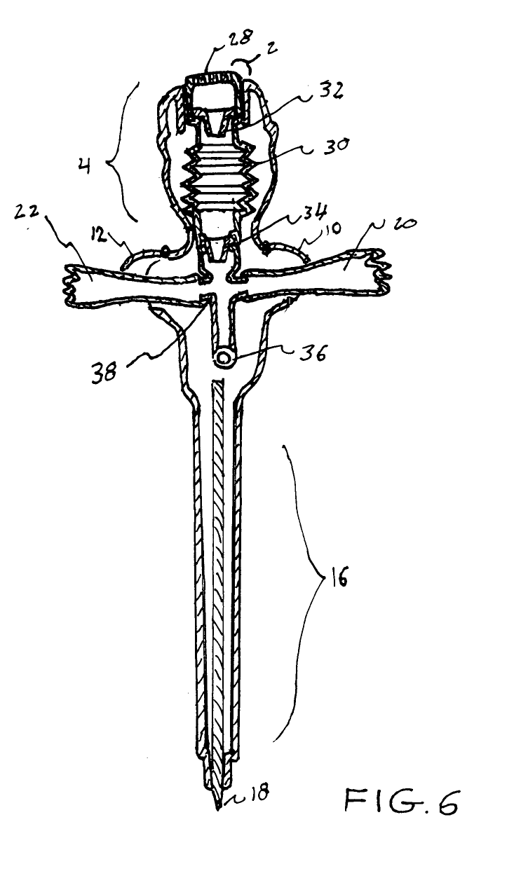

FIG. 6 shows the same front section view as in FIG. 5 except the extendable arms 20, 22 are partially inflated. as push button 2 has been pressed by the user. Inflatable extension arms 20, 22 are fastened and retained by standard means to rigid tubular apertures 38.

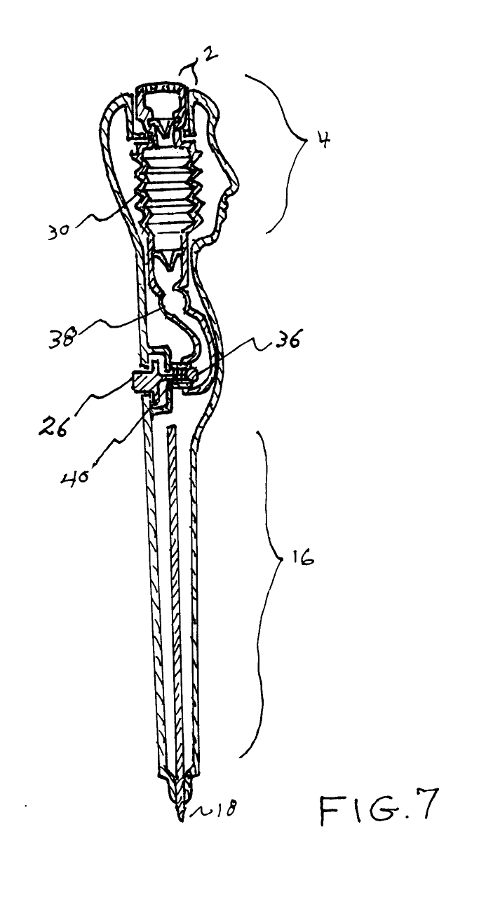

FIG. 7 shows a side section view of the invention that vertically bisects the invention. Relief valve 36 can be clearly seen, as well as valve release push button 26 which is spring biased by spring 40. Relief valve ball 36 extends forward when button 26 is pressed thereby releasing trapped air from inflatable members 20, 22.

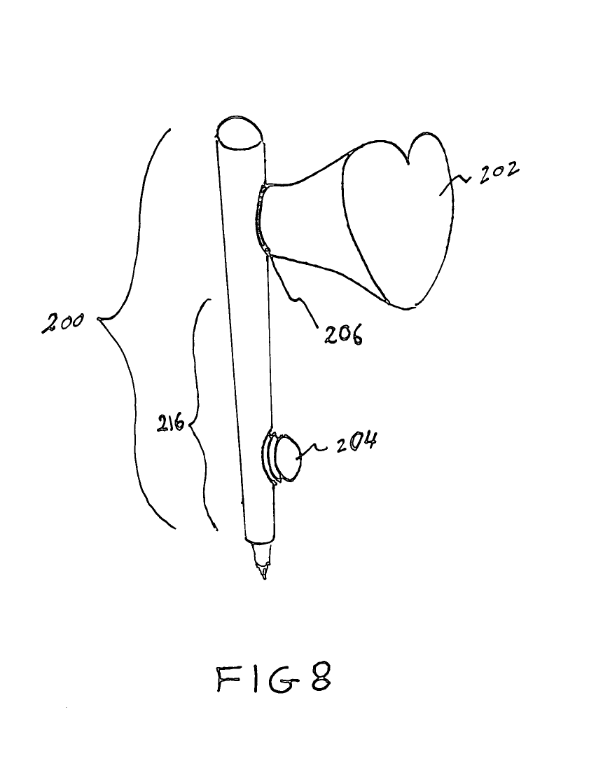

FIG. 8 shows an alternate embodiment 200 of the present invention where the bellows pump mechanism 204 is positioned low on hollow elongate member 216 and is in the position where the user's fore finger tip can rest. In this configuration, the user can inflate the expandable member 202 while his or her hand remains in the normal writing position. In this embodiment 200 a heart shaped balloon 202 exits an aperture 206 in the housing 216 wall.

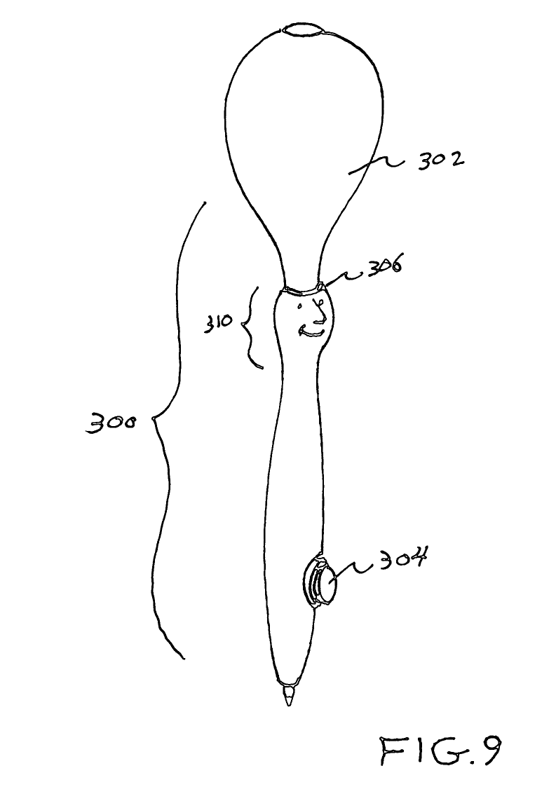

FIG. 9 shows another alternate embodiment 300 where a light bulb shaped inflatable member 302 has exited from an aperture 306 in the head portion 310 of the pen housing.

Obviously, other known features can be added to the present invention, including: LED lights, audio sounds and other mechanical moving or non moving parts that may help add novelty and enjoyment to the present invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. novelty writing instrument with pneumatic feature comprising:
a rigid elongate hollow writing instrument housing;
a pneumatic pump mechanism;
a pneumatic pump activating push button;
one or more flexible inflatable members;
a relief valve;
said pump mechanism located within said hollow writing instrument housing;
said pump activating button protruding through an aperture on the surface of said hollow writing instrument housing;
said pneumatic pump activated by the user pressing on the surface of said pneumatic pump activating push button;
said inflatable members attached in an air tight manner to said pneumatic pump;
said housing having apertures that allow said flexible inflatable members to exit said housing when said pump mechanism is activated and said inflatable members are inflated;
said inflatable members terminating in said relief valve; and
said relief valve having a relief push button that exits through an aperture in said writing instrument housing and is accessible to a user for deflating said inflatable members.

2. A novelty writing instrument with pneumatic feature as claimed in claim 1 wherein said said inflatable members are latex balloons.

3. A novelty writing instrument with pneumatic feature as claimed in claim 1 wherein said hollow writing instrument housing is shaped to look like a person or animal and where said inflatable members resemble extendible arms.

4. A novelty writing instrument with pneumatic feature as claimed in claim 1 wherein said pneumatic pump mechanism is located in the head portion of said person or animal shape and said pneumatic pump activating push button if formed by the top of said head portion.

5. A novelty writing instrument with pneumatic feature as claimed in claim 1 wherein said inflatable members are retained by hinged panels located on the left and right side walls of said writing instrument housing;
said panels capable of retaining said inflatable members when in a deflated mode, and then rotating upward via said hinges when said members are inflated by said user.

6. An embodiment of said novelty writing instrument with pneumatic feature as claimed in claim 1 wherein said pneumatic pump mechanism is located on the lower side portion of the said hollow writing instrument housing enabling the user to inflate said inflatable members while said user's fingers are in the normal writing position.

7. An embodiment of said novelty writing instrument with pneumatic feature as claimed in claim 1 wherein said inflatable member is heart shaped and exits an aperture in the chest portion of said person or animal shaped housing.

8. An embodiment of said novelty writing instrument with pneumatic feature as claimed in claim 1 wherein said inflatable member is a light bulb shape and exits an aperture located at the top portion of said person or animal shaped housing.
